(19) United States
(12) Patent Application Publication
(10) Pub. No.: US 2004/0013261 A1
(43) Pub. Date: Jan. 22, 2004

(54) Administrative protection of groups in public switching systems

(76) Inventors: Joachim Huttel, Munich (DE); Irena Romanski, Egling (DE)

Correspondence Address: MORRISON & FOERSTER LLP, 1650 TYSONS BOULEVARD, SUITE 300, MCLEAN, VA, 22102, US

(21) Appl. No.: 10/221,493

(22) PCT Filed: May 2, 2001
(86) PCT No.: PCT/DE01/01658

(30) Foreign Application Priority Data
May 4, 2000 (DE) 100 21 778.8

(51) Int. Cl. H04M 3/00; H04M 5/00

(52) U.S. Cl. 379/242

(57) ABSTRACT

The invention relates to a switching centre (1) for connecting telephone objects (2a . . . 2n) to a telephone network, comprising a control device (3) wherein operational functions can be administered by authorized operators by inputting commands via a terminal (6), and verification means (4) for checking access authorization enabling certain operators to administer within a group (5). The invention also relates to a method for administering operations functions in the switching centre.

The present invention relates to a switching center for connecting telephone objects to a telephone network, in which operating functions are administered by means of commands, input by authorized operators by way of a terminal, as described in the preamble to the attached claim 1, and a method used in this switching center for the administration of operating functions, as it is described in the preamble to the attached claim 9.

Several telephone objects, e.g., telephone terminals or telephone private branch exchanges of terminals connected to this switching center, can be brought together in groups in a switching center in a telephone network. This group formation is useful in the CENTREX service (Centralized Office Exchange Service), for example.

CENTREX is a special service in a network node, i.e., in a switching center, which makes the functionality similar to a private branch exchange available to part of the connected terminals of subscribers.

Switching centers can be administered by authorized operators or persons by input of commands (e.g., in man-machine language, MML), by way of a terminal, i.e., operating functions such as setting up terminals or assigning specific authorization to terminals or subscribers, with regard to features, for example, can be carried out.

In the state of the art, a protection function of the switching center is implemented locally per switching center, in order to protect it from unauthorized access, per individual (MML) command. This means that an operator who is authorized to administer operating functions of the switching center has access to the entire switching center within the scope of his/her authorization for this switching center (for specific MML commands), or to all the telephone objects connected to it. Individual MML commands can generally be carried out by several operators. Thus, for example, access to individual groups of telephone objects can be carried out without coordination.

This has the disadvantage that operationally secure administration of individual groups of telephone objects, for example, is not possible.

It is therefore the task of the present invention to make available a switching center for connecting telephone objects to a telephone network, according to the preamble of the attached claim 1, and a method used in this switching center, for the administration of operating functions, according to the preamble of the attached claim 9, in which greater operational security in the administration of operating functions is possible.

This task is accomplished by means of a switching center as recited in the attached claim 1 and a method used in this switching center, for the administration of operating functions, as recited in the attached claim 9.

The following advantages result from checking, according to the invention, whether or not a specific operator is authorized for the administration of a specific group:

Security is provided to prevent unauthorized or accidental administration by unauthorized operators. Furthermore, there is a savings potential for the telecommunications companies, since the protective measure allows the use of less qualified personnel for administration. In addition, customers of the telecommunications companies who are organized in such groups are no longer hindered or disturbed by unauthorized or accidental administration of their telecommunications devices. The protection is furthermore possible both locally (in a switching center) and network-wide over the telephone network (in several) switching centers.

Advantageous embodiments of the present invention are indicated in the respective dependent claims.

According to the present invention, several groups can be organized in a switching center, each of them having different access authorizations.

The individual groups are identified with different group identifiers (IDs), so that only those operators who are authorized to administer a group can access the respective groups. An association of the operator ID and the group ID is created for this purpose. Access authorization is then checked by checking the identifier (user identification, user ID) contained in an administrative command to determine whether or not it is linked with the group ID, and therefore whether or not the administrative command (with the user ID, in each instance) is allowed to be carried out by the operator in question.

According to the present invention, the individual groups do not have to be limited to one switching center. A group (e.g., terminals of a company) can also extend over several switching centers (e.g., branch offices of a company).

The administration of a group in a switching center can take place both locally for a switching center and centrally for all the switching centers in which the group is present.

In the following, the present invention will be explained in greater detail on the basis of preferred exemplary embodiments, making reference to the attached drawings, which show:

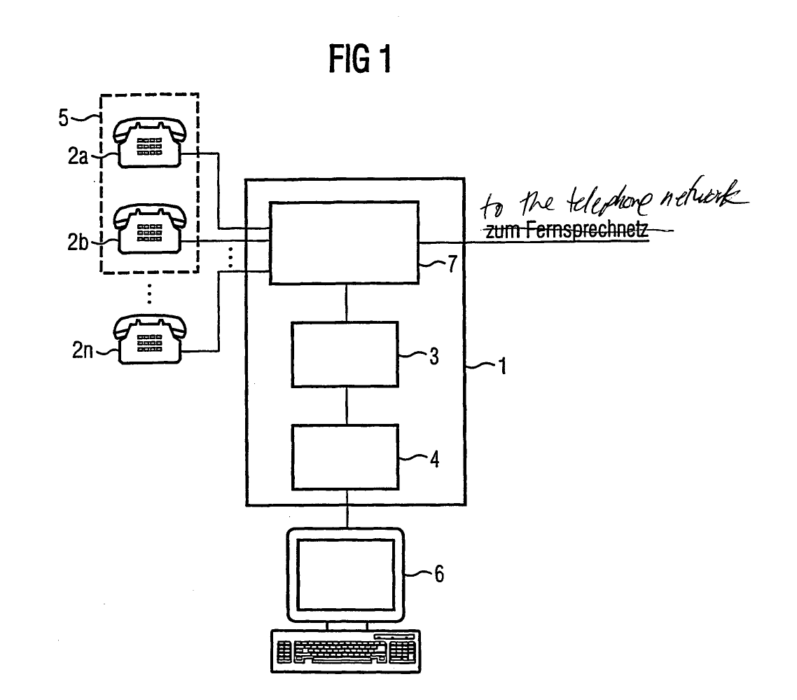

FIG. 1 a schematic representation of the switching center according to the invention;

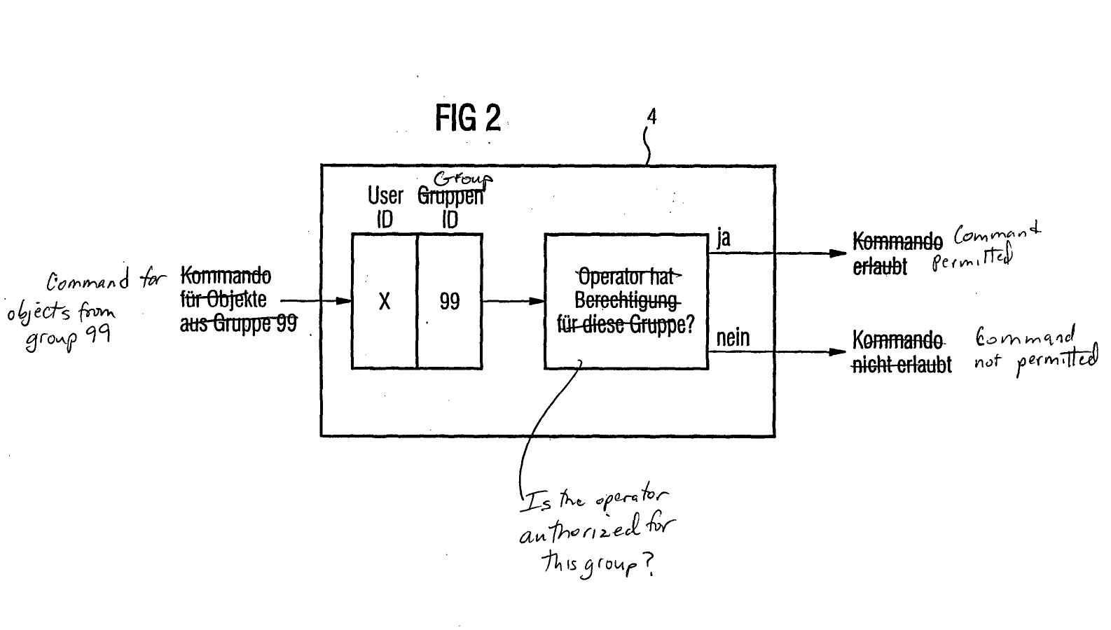

FIG. 2 the schematic representation of the authorization check in the switching center;

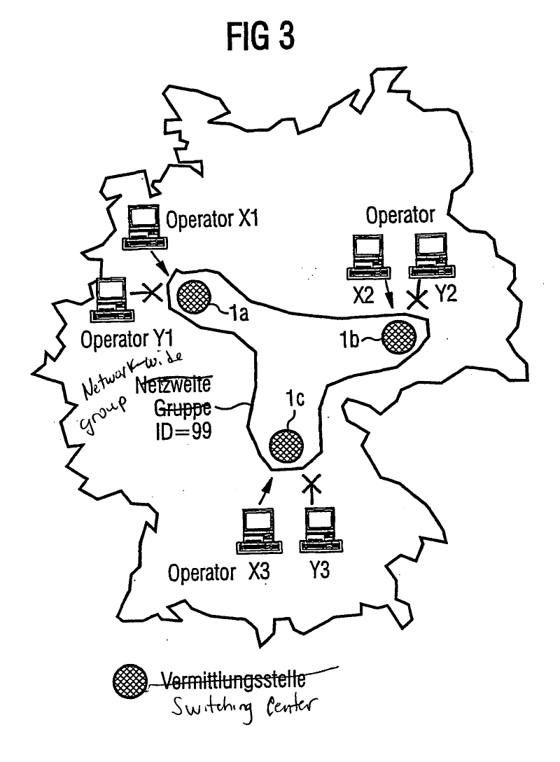

FIG. 3 an example of the network-wide group in the case of local administration;

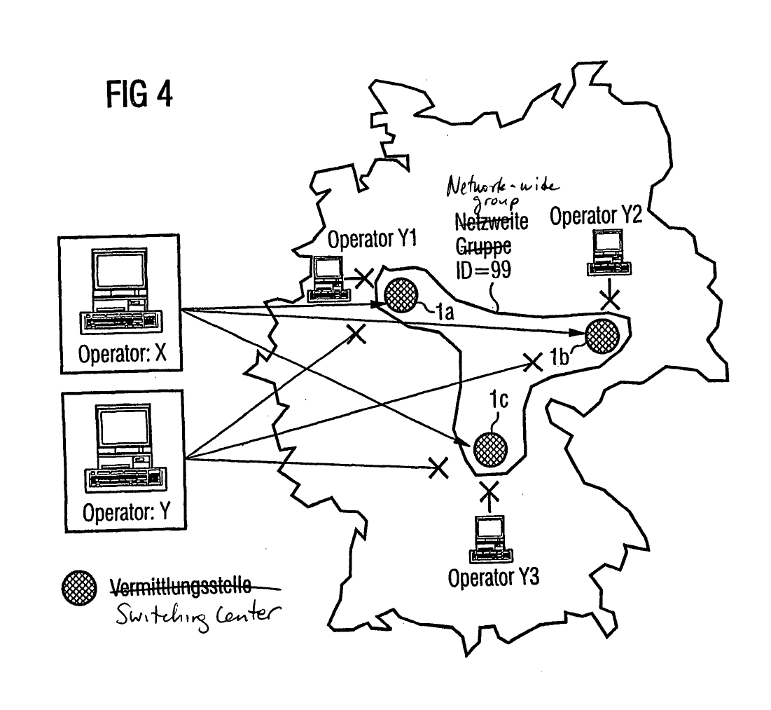

FIG. 4 an example of a network-wide group in the case of centralized network-wide administration;

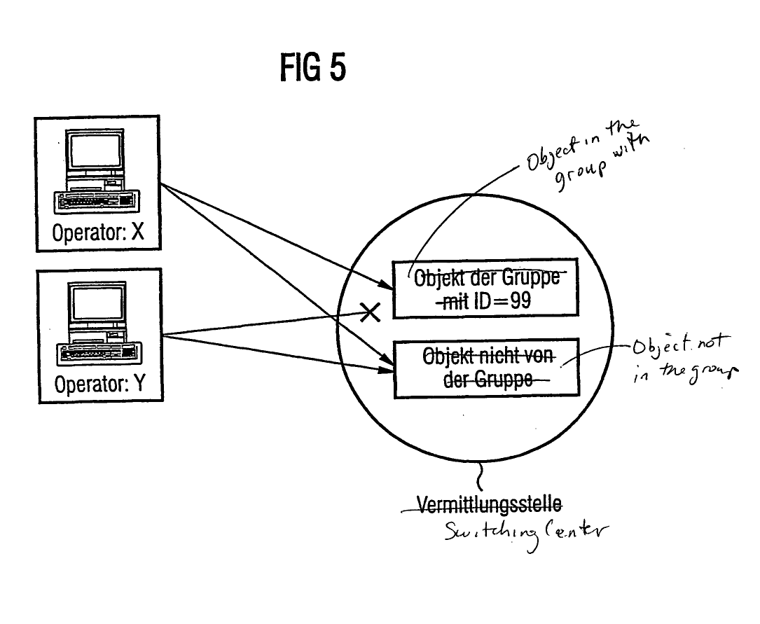

FIG. 5 an example of the protection effect in a switching center.

The schematic structure of the switching center 1 according to the invention will be explained in the following, using FIG. 1.

The subscribers are connected to the switching center 1 with their terminals (telephone objects) 2a . . . 2n. The switching center contains the switching devices 7 for switching and connecting the subscribers with the telephone network, such as the connection units (Line Cards) for connecting the terminals 2a . . . 2n to the switching center, and the coupling network for switching the connection. These switching devices 7 can be controlled or administered in their operating functions, such as [by] the establishment of new subscribers, by means of a control device 3.

As already described initially, several telephone objects (e.g., terminals 2a, 2b or private branch exchanges) can be organized in a group 5, e.g., in the CENTREX service. In this connection, the switching center 1 makes the functionality of a private branch exchange available to a company, for example, without any need for the company to acquire a private branch exchange. The number of telephone objects that belong to a group is not limited, and can be established by the telecommunications company. A group can also extend network-wide over several switching centers, in which case the telephone objects then belong to the branch offices of a company, for example.

Administration of the operating functions takes place by means of inputting commands (e.g., in man-machine language, MML) at a terminal 6. Checking whether or not an operator accessing the switching center in this regard is authorized to administer operating functions takes place, in this connection, by the operator inputting commands by means of the checking device 4. Advantageously, this checking device 4 is implemented as software in the control device 3.

The invention ensures that only selected operators of the telecommunications company are permitted to administer individual groups and the telephone objects contained in them. This assures greater security in the administration of the individual group, in order to avoid uncoordinated access or unauthorized access, for example.

For this purpose, a group ID is assigned to every group in every switching center in which the group in question is represented.

FIG. 2 shows that the checking device 4 for checking access authorization carries out assignment of an operator (in the example with the user ID X) to a group (in the example with the group ID 99). In this connection, incoming commands contain the identifier (user ID and/or password) of the accessing operator. The checking device uses stored identifiers to check whether or not the operator in question is authorized to carry out this command for the group at which this command is directed.

In the authorization check, the checking device uses identifiers stored in memory to check whether or not the operator who is providing the input is authorized to administer this command for the group to which this command is directed, and therefore to administer the telephone objects contained in it. If this is the case, the command is accepted; if not, it is rejected. The number of different telephone objects per group and therefore the number of different (MML) commands can be set individually per group by the telecommunications company.

The group ID is uniformly assigned for all members of a group in the individual switching centers in which the group is present, and thereby a network-wide group is formed (consisting, for example, of all the branch offices of a company that are present in the telephone network). This is done by means of corresponding (MML) commands that are stored in memory for each member of the group in the corresponding switching center.

Furthermore, a definition is established as to what telephone objects (e.g., terminals, private branch exchanges) are supposed to belong to the group, and thereby the (MML) commands that are necessary to administer the group and the telephone objects contained in it are established.

The network administrator who assigns the identifiers (IDs) himself/herself has access to all administratively supported switching centers and groups.

The example of FIG. 3 makes it clear how the administrative protection for a network-wide group functions in the case of local administration.

The network-wide group (i.e., the individual members of a group) is represented in three switching centers 1a, 1b, 1c. The members of a group are, in each instance, provided with the same group ID (99, in the example) in every switching center 1a, 1b, 1c, and assigned to the operator with the user ID X. Therefore access to the group with the group ID=99 and the telephone objects contained in it is not possible for operator Y, although this operator is fundamentally authorized to administer operating functions of the switching center.

In another example, in FIG. 4, the administration protection for a network-wide group is explained for the case of centralized network-wide administration.

The network-wide group is represented in the three switching centers 1a, 1b, 1c. The members of the group are provided with the same group ID in each switching center 1a, 1b, 1c, and assigned to the operator X. This means that access to the group and the telephone objects of the group is not possible for the central operator Y and the operators Yl, Y2, Y3 directly connected to the switching center in question, although these operators would fundamentally be authorized to administer these switching centers 1a, 1b, 1c. This shows the possibility of delimitation relative to other administrative offices of the telecommunications company in the case of network-wide central administration: other than operator X, nobody, not even the other network-wide administrative office represented by operator Y, or the local administrative offices represented by operators Yl, Y2, Y3, has access to the group, although operator Y would fundamentally have access to the switching centers 1a, 1b, 1c, and the operators Yl, Y2, Y3 would have access to the switching center 1a, 1b, 1c, respectively.

This makes a total delimitation with regard to operation possible relative to other administrative offices of the telecommunications company, e.g., the basic setup of subscribers (terminals) can be uncoupled from other administration.

In the following, it will be explained, using FIG. 5, how the protection effect functions within a switching center. This figure makes it clear that the protection is not effective per switching center, but rather within a switching center, individually by group. Operator X can access a telephone object with the group ID=99 (e.g., a terminal of a subscriber), as well as other (unprotected) telephone objects (of other subscribers). Operator Y can also administer subscribers, but not those from the protected group with the group ID=99.

1. Switching center (1) for connecting telephone objects (2a . . . 2n) to a telephone network, part of the telephone objects (2a, 2b) being organized in a group (5), with
a control device (3) in which operating functions are administered by authorized operators, by means of inputting commands by way of a terminal (6), and
a checking device (4) for checking access authorization, which permits the administration of operating functions of the switching center (1) by authorized operators, characterized in that
the checking device (4) for checking an access authorization checks whether or not an accessing operator is permitted to administer the operating functions of the group (5).

2. The switching center (1) as recited in claim 1, characterized in that
a plurality of groups is present in a switching center (1), and that the checking device (4) for checking access authorization checks whether or not an accessing operator is permitted to administer the operating functions of a specific group (5).

3. The switching center (1) as recited in claim 2, characterized in that
the groups (5) are each provided with a group identifier, in order to identify them clearly.

4. The switching center (1) as recited in one of claims 1 to 3, characterized in that
a group (5) in the telephone network extends over several switching centers (1).

5. The switching center (1) as recited in one of claims 1 to 4,
characterized in that
a group (5) consists of terminals that belong to a virtual private branch exchange.

6. The switching center (1) as recited in one of claims 2 to 5,
characterized in that
the checking device (4) for checking an access authorization undertakes a comparison association of the group ID and the user ID of the operator, in order to check whether or not an accessing operator is authorized to perform operating functions of a specific group.

7. The switching center (1) as recited in one of claims 1 to 6,
characterized in that
the administration takes place locally for one switching center (1).

8. The switching center (1) as recited in one of claims 1 to 7,
characterized in that
the administration takes place centrally for several switching centers (1).

9. Method for controlling operating functions in a switching center (1) for connecting terminals (2a . . . 2n) to a telephone network, in which operating functions are administered by authorized operators, by means of inputting commands by way of a terminal (6), part of the terminals (2a, 2b) being organized in a group (5), and in which a check takes place in the administration of operating functions of the switching center (1), to determine whether or not the operator in question is authorized to administer operating functions, characterized in that
a check takes place to determine whether or not an accessing operator is permitted to administer the operating functions of the group (5).

10. The method as recited in claim 9,
characterized in that
a check takes place to determine whether or not an accessing operator is permitted to administer the operating functions of a group (5), out of a plurality of groups.

11. The method as recited in claim 10,
characterized in that
the groups (5) are each provided with a group identifier, in order to identify them clearly.

12. The method as recited in claim 9, 10, or 11,
characterized in that
a group (5) extends network-wide over several switching centers (1).

13. The method as recited in claim 9 to 12,
characterized in that an association of the group ID and the user ID of the operator is undertaken, in order to check whether or not a specific operator is authorized to perform operating functions of a selected group.

14. The method as recited in one of claims 9 to 13,
characterized in that
the administration takes place locally for one switching center (1).

15. The method as recited in one of claims 9 to 14,
characterized in that
the administration takes place centrally for several switching centers.
